(19) United States
(12) Patent Application Publication
(10) Pub. No.: US 2009/0265944 A1
(43) Pub. Date: Oct. 29, 2009

(54) SAW BOW FOR HANDSAW

(75) Inventor: Walley CHAO, Nantou County (TW)

Correspondence Address: BROWDY AND NEIMARK, P.L.L.C.;624 NINTH STREET, NW, SUITE 300, WASHINGTON, DC, 20001-5303, US

(73) Assignee: K &W TOOLS CO., LTD, NANTOU CITY (TW)

(21) Appl. No.: 12/251,965

(22) Filed: Oct. 15, 2008

(30) Foreign Application Priority Data
Apr. 29, 2008 (TW) 97115732

(51) Int. Cl. B27B 21/06; B27B 21/02

(52) U.S. Cl. 30/510; 30/513

(57) ABSTRACT

A saw bow for a handsaw includes a saw bow body, a movable member movably mounted in a bottom of a handle of the saw bow body and movable relative to the handle along a longitudinal direction of the saw bow body, a bottom cover having a first pivotal portion pivotally connected with the handle of the saw bow body and a second pivotal portion, and a length-adjustable member having two ends respectively pivotally connected with a pivotal end of the movable member and the second pivotal portion of the bottom cover. As a result, the saw bow of the present invention can provide a congruous appearance and occupy less storage space.

### BACKGROUND OF THE INVENTION

1. Field of the Invention

The present invention relates generally to a handsaw, and more specifically to a saw bow for a handsaw that can provide a congruous appearance and occupy less space when it is storied.

2. Description of the Related Art

Before using a conventional handsaw, a user needs to turn a wing nut to adjust the tensile status of a saw blade. If the tensile status of the saw blade is too loose, the saw blade may be deformed or cracked easily when it cuts a workpiece, resulting in that it will be difficult to get a straight cutting on the workpiece. On the contrary, if the tensile status of the saw blade is adjusted too tight, the saw bow, to which the saw blade is fastened, may be deformed or damaged.

In addition, the wing nut has a part screwed into an end of the saw bow and another part protruding outwardly from an outer surface of the saw bow, resulting in that the conventional saw bow shows an incongruous appearance and occupies much space when it is in storage because of the existence of the protruded wing nut.

### SUMMARY OF THE INVENTION

The present invention has been accomplished in view of the above-noted circumstances. It is one objective of the present invention to provide a saw bow, which has a congruous appearance and occupies less space when it is in storage.

To achieve this objective of the present invention, the saw bow comprises a saw bow body having a handle, a movable member movably mounted in a bottom of the handle of the saw bow body and movable relative to the handle along a longitudinal direction of the saw bow body and provided with a pivotal end receivable in the handle, a bottom cover having a first pivotal portion pivotally connected with the bottom of the handle of the saw bow body, and a second pivotal portion spaced from the first pivotal portion, and a length-adjustable member having two ends, one of which is pivotally connected with the pivotal end of the movable member and the other of which is pivotally connected with the second pivotal portion of the bottom cover.

When the bottom cover is pivotally moved away from the handle of the saw bow body, the length-adjustable member is exposed to the outside to be adjustable in its length, resulting in that the tensile status of a saw blade having two ends that are respectively connected with the moveable member and an end of the saw bow body is accordingly adjustable. After the adjustment work of the length-adjustable member is completed, the bottom cover can be pivotally moved toward the handle of the saw bow body for hiding the length-adjustable member in the handle of the saw bow body such that the saw bow can provide a congruous appearance and occupy less storage space.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below and the accompanying drawings which are given by way of illustration only, and thus are not limitative of the present invention, and wherein:

FIG. 1 is an exploded view of a saw bow according to a preferred embodiment of the present invention;

FIG. 2 is a lateral view of the saw bow according to the preferred embodiment of the present invention;

FIG. 3 is a partially cutaway lateral view of the saw bow according to the preferred embodiment of the present invention;

FIG. 4 is another lateral view of the saw bow according to the preferred embodiment of the present invention, showing the bottom cover is pivotally moved away from the handle of the saw bow, and

FIG. 5 is similar to FIG. 4 but the bottom portion of the saw bow is partially cutaway.

### DETAILED DESCRIPTION OF THE INVENTION

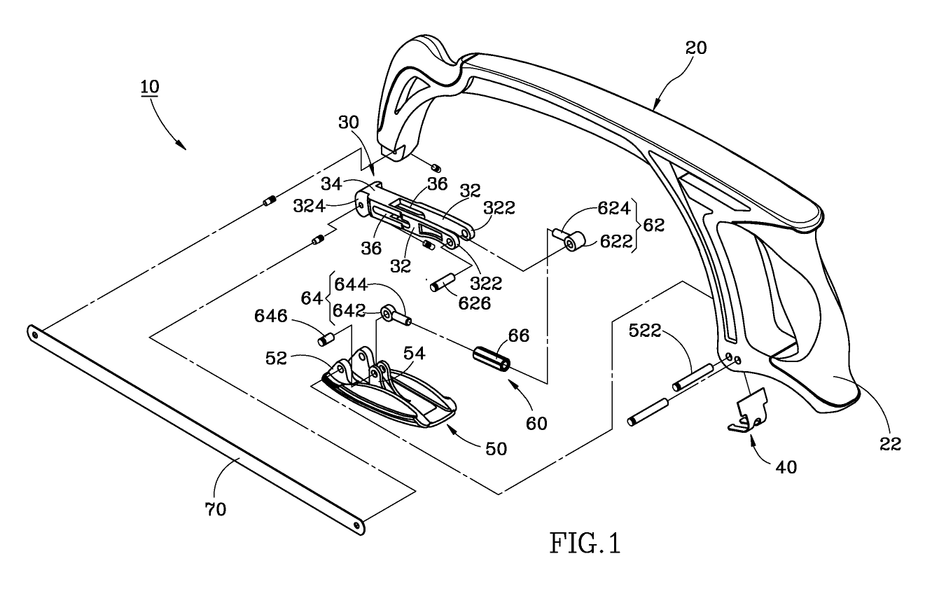

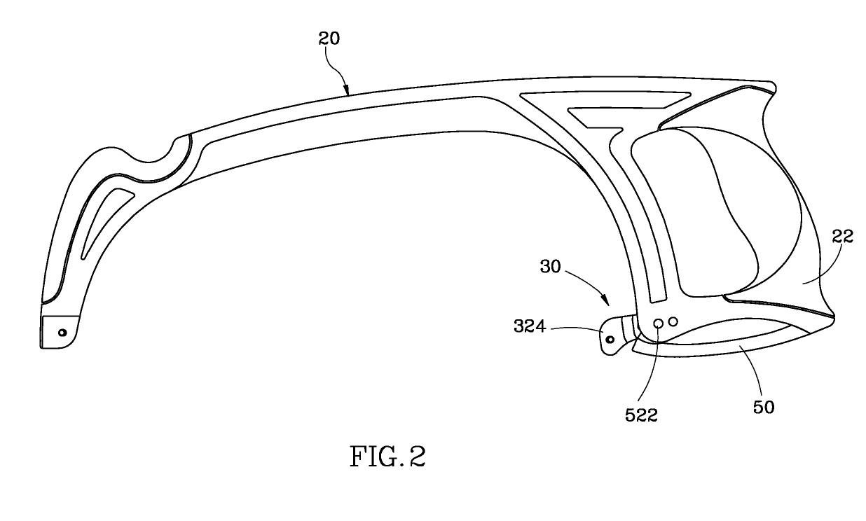

As shown in FIGS. 1 and 2, a saw bow 10 in accordance with a preferred embodiment of the present invention comprises a saw bow body 20, a movable member 30, an elastic member 40, a bottom cover 50, and a length-adjustable member 60.

The saw bow body 30 has a front end for fastening of a front end of a saw blade 70, and a rear end with a hollow handle 22 for holding by a user.

The movable member 30 has two opposite side walls 32 and a top wall 34 connected with the side walls 32. The side walls 32 each have a rear end to form a pivotal end 322 of the movable member 30 inside the handle 22, a front end to form a connection end 324 of the movable member 30 for fastening of a rear end of the saw blade 70, and an elongated groove 36.

The elastic member 40 is mounted in the handle 22 and stopped against the top wall 34 of the movable member 30.

The bottom cover 50 is provided at a front end with two first lugs to form a first pivotal portion 52, and at a middle part with two second lugs to form a second pivotal portion 54 adjacent to the first pivoting portion 52. The bottom cover 50 is pivotally connected with a bottom of the handle 22 by means of a first pivot 522 passing thought the handle 22, the first lugs of the bottom cover 50, and the elongated grooves 36 of the side walls 32 of the moveable member 30, such that the bottom cover 50 is pivotable relative to the handle 22

The length-adjustable member 60 includes a first bolt 62 having a first head portion 622 pivotally connected with the pivotal end 322 of the movable member 30 by a second pivot 626, and a threaded first body portion 624, a second bolt 64 having a second head portion 642 pivotally connected with the second pivotal portion 54 of the bottom cover 50 by a third pivot 646 passing through the second pivoting portion 54, and a threaded second body portion 644, and a nut 66 having two ends respectively screwingly engaged with the first body portion 624 of the first bolt 62 and the second body portion 644 of the second bolt 64.

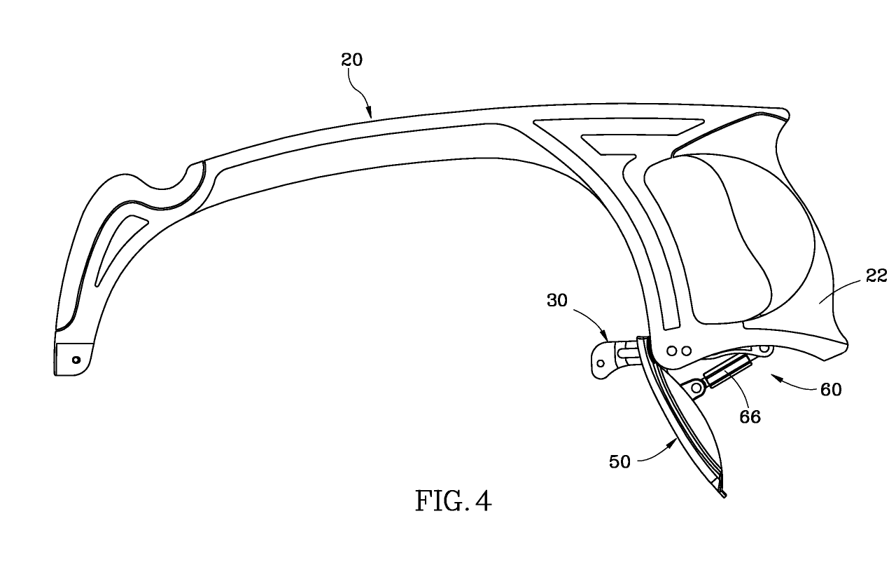

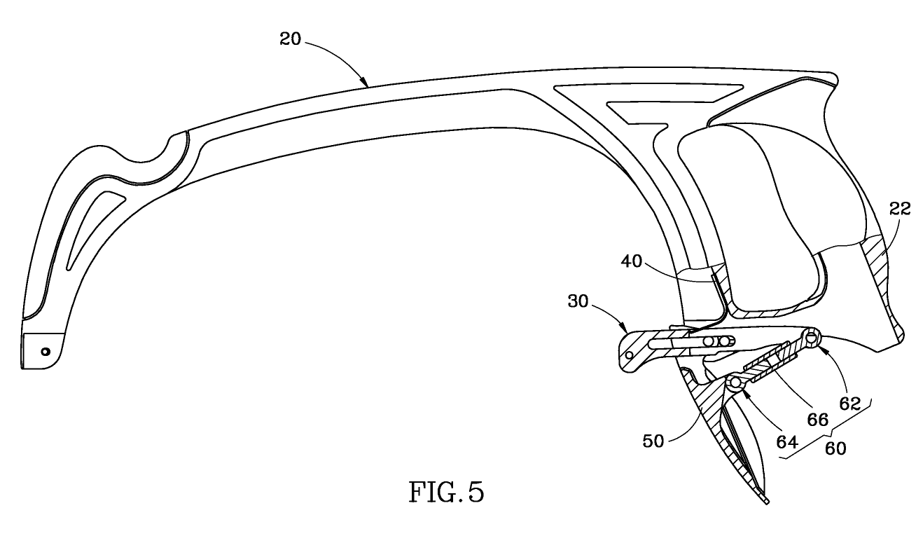

To adjust the tensile status of the saw blade 70, a user may force the bottom cover 50 to be pivotally moved away from the handle 22, as shown in FIGS. 4 and 5, such that the movable member 30 can be moved forwards along a longitudinal direction of the saw bow body 20 by means of the turning actuation of the bottom cover 50 and the pushing force of the length-adjustable member 60, thereby causing the length-adjustable member 60 to be exposed to the outside. Thereafter, the user can subsequently turn the nut 66 to adjust the length of the length adjust member 60 to tighten or loosen the tensile status of the saw blade 70. In this embodiment, the tensile status of the saw blade 70 will become tight if the user turns the nut 66 clockwise, and it will become loose if the user turns the nut 66 counterclockwise.

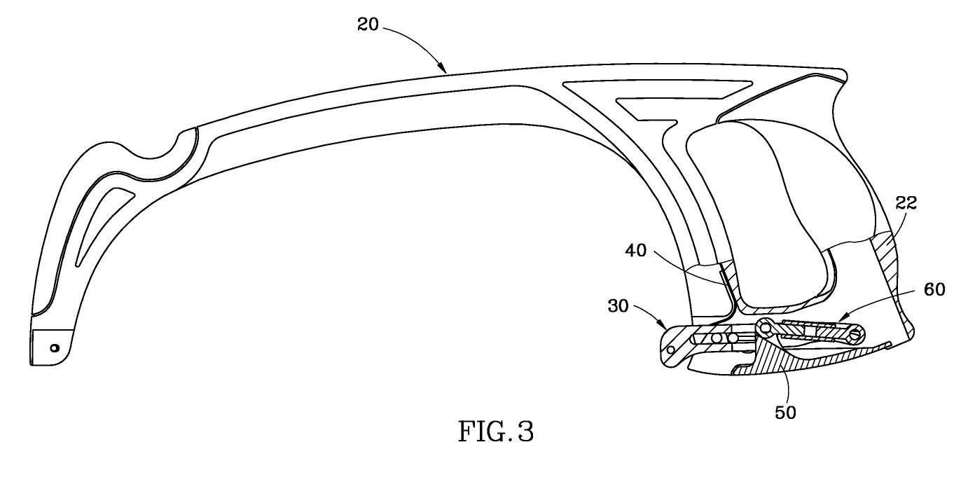

After completing the adjustment work of the saw blade 70, the user may push the bottom cover 50 to pivotally move back to the bottom of the handle 20 such that the movable member 30 will be moved backwards along the longitudinal direction of the saw bow body 20, resulting in that the length-adjustable member 60 is located inside the handle 22 without exposing to the outside, as shown in FIGS. 2 and 3. During the movement of the movable member 30, the elastic member 40 will provide an elastic force to the movable member 30 such that the movable member 30 can be moved smoothly.

Accordingly, by means of the pivotal movement of the bottom cover, the length-adjustable member can be exposed to the outside or accommodated inside the handle such that the saw bow of the present invention can obtain a congruous appearance and occupy less storage space

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A saw bow for a handsaw, said saw bow comprising:
a saw bow body having a handle;
a movable member movably mounted in a bottom of said handle of said saw bow body and movable relative to said handle along a longitudinal direction of said saw bow body, said moveable member having a pivotal end receivable in said handle of said saw bow body;
a bottom cover having a first pivotal portion pivotally connected with said bottom of said handle of said saw bow body, and a second pivotal portion spaced from said first pivotal portion; and
a length-adjustable member having two ends, one of which is pivotally connected with said pivotal end of said movable member and the other of which is pivotally connected with said second pivotal portion of said bottom cover.

2. The saw bow as claimed in claim 1, wherein said movable member includes two opposite side walls each having a rear end to form said pivotal end and an elongated groove, and said bottom cover includes two lugs to form said first pivotal portion; said bottom cover is pivotally connected with said handle by means of a pivot passing through said handle, said lugs, and said elongated grooves.

3. The saw bow as claimed in claim 2, further comprising an elastic member mounted in said handle and abutted against a top wall of said movable member; wherein said top wall is connected with said side walls of said movable member.

4. The saw bow as claimed in claim 1, wherein said length-adjustable member has a first bolt pivotally connected with said pivotal end of said movable member, a second bolt pivotally connected with said second pivotal portion of said bottom cover, and a nut screwingly engaged with said first bolt and said second bolt.
